(19) United States
(12) Patent Application Publication
(10) Pub. No.: US 2025/0291344 A1
(43) Pub. Date: Sep. 18, 2025

(54) METHOD, SYSTEM AND STORAGE MEDIUM FOR DETECTING ABNORMALITY OF MECHANICAL PROCESSING EQUIPMENT

(71) Applicant: Aktiebolaget SKF, Göteborg (SE)

(72) Inventors: Jinshi CUI, Shanghai (CN); Kaihuan ZHANG, Hangzhou (CN)

(21) Appl. No.: 19/071,091

(22) Filed: Mar. 5, 2025

(30) Foreign Application Priority Data
Mar. 15, 2024 (CN) 202410297697.7

(51) Int. Cl. G05B 23/02

(52) U.S. Cl. CPC G05B 23/0254

(57) ABSTRACT

A method, system, and storage medium for detecting abnormality of mechanical processing equipment. The method includes obtaining processing data of the mechanical processing equipment during machining of a workpiece, obtaining a type of the workpiece of the processing data, separating the processing data based on the type of machined workpiece, selecting a machine learning model corresponding to the workpiece type of the separated processing data to process the separated processing data to obtain an abnormality detection result. With the method for detecting abnormality of mechanical processing equipment disclosed in the present disclosure, abnormality of the mechanical processing equipment can be accurately detected, thereby improving the yield rate of the processed workpiece.

### CROSS-REFERENCE TO RELATED APPLICATION

This application is based on and claims priority to Chinese Patent Application No. 202410297697.7, filed on Mar. 15, 2024 in the Chinese Patent Office, the entirety of which is herein incorporated by reference.

### FIELD

The present disclosure relates to a method, system and storage medium for detecting abnormality of mechanical processing equipment.

### BACKGROUND

Various mechanical processing equipment may have abnormalities such as abnormal vibrations during operation. Currently, in order to detect abnormalities in mechanical processing equipment, maintenance engineers can evaluate abnormalities or failures of mechanical processing equipment by measuring relevant data when the mechanical processing equipment is running/stopped, or they can detect abnormalities based on upper and lower thresholds of processing data set for the mechanical processing equipment. However, depending on the qualifications of the maintenance engineers themselves, there is a great deal of uncertainty in the evaluation of mechanical processing equipment by maintenance engineers. In addition, since mechanical processing equipment may process different workpieces, it may be very challenging to accurately detect abnormalities in mechanical processing equipment based on the unified upper and lower thresholds of processing data set for the mechanical processing equipment. Therefore, there is a need for a method that can detect abnormalities in mechanical processing equipment based on the specific processing conditions of the mechanical processing equipment.

### SUMMARY

According to an embodiment of the present disclosure, there is provided a method for detecting abnormality of a mechanical processing equipment, comprising: obtaining processing data of the mechanical processing equipment during machining of a workpiece, obtaining a type of the workpiece of the processing data, separating the processing data based on the type of machined workpiece, selecting a machine learning model corresponding to the workpiece type of the separated processing data to process the separated processing data to obtain an abnormality detection result.

According to the method for detecting abnormality of the embodiment of the present disclosure, wherein the processing data comprises at least one of mechanical power output and electrical power received by the mechanical processing equipment during machining of the workpiece.

According to the method for detecting abnormality of the embodiment of the present disclosure, wherein the type of the workpiece in the processing data is obtained by using a scheduling history in the mechanical processing equipment and the processing data is separated.

According to the method for detecting abnormality of the embodiment of the present disclosure, wherein obtaining processing data of the mechanical processing equipment during processing of the workpiece comprises: obtaining the full-period processing data including processing data during the processing period and processing data during the stopping period, removing the processing data during the stopping period from the full-period processing data to obtain the processing data during the processing period; and wherein, selecting the machine learning model corresponding to the workpiece type of the separated processing data to process the separated processing data includes: processing the processing data during the processing period in the separated processing data.

According to the method for detecting abnormality of the embodiment of the present disclosure, wherein the processing data during the stopping period is removed from the full-period processing data by a machine learning classification model or based on a threshold.

According to the method for detecting abnormality of the embodiment of the present disclosure, wherein obtaining processing data of the mechanical processing equipment during processing of the workpiece further comprises: removing the impact pulse data of the mechanical processing equipment at startup and shutdown from the processing data during the processing period to obtain the processing data during the effective processing period; and wherein, selecting the machine learning model corresponding to the workpiece type of the separated processing data to process the separated processing data includes: processing the processing data during the effective processing period in the separated processing data.

According to the method for detecting abnormality of the embodiment of the present disclosure, further comprising: obtaining the processed part of the processed workpiece, separating the processing data based on the type and processed part of the processed workpiece, selecting the machine learning model corresponding to the workpiece type and processed part of the separated processing data to process the separated processing data to obtain the abnormality detection result.

According to the method for detecting abnormality of the embodiment of the present disclosure, further comprising: obtaining the processing stage of the processed workpiece, separating the processing data based on the type of the processed workpiece, the processed part and the processing stage, selecting the machine learning model corresponding to the workpiece type, processed part, and processing stage of the separated processing data to process the separated processing data to obtain the abnormality detection result.

According to the method for detecting abnormality of the embodiment of the present disclosure, wherein the processed part of the workpiece and processing stage in the processing data are obtained based on the mechanical processing principle of the processed workpiece or machine learning classification model.

According to an embodiment of the present disclosure, there is provided an abnormality detection system for mechanical processing equipment, comprising: a sensor unit, including one or more sensors, configured to collect processing data about the mechanical processing equipment; an abnormality detection model library, including one or more abnormality detection models configured to perform abnormality detection on mechanical processing equipment; and the processor is configured to: obtain processing data of the mechanical processing equipment during machining of a workpiece from the sensor unit, obtain a type of the workpiece of the processing data, separate the processing data based on the type of machined workpiece, select a machine learning model corresponding to the workpiece type of the separated processing data from the abnormality detection model library to process the separated processing data to obtain an abnormality detection result.

According to an embodiment of the present disclosure, there is provided a non-transitory storage medium on which instructions are stored. When executed by a processor, the instructions enable the processor to execute the method for detecting abnormality for mechanical processing equipment as described above.

According to the method for detecting abnormality of a mechanical processing equipment disclosed in the present disclosure, by processing the processing data using a machine learning abnormality detection model related to the workpiece type, processed part, and processing stage, the anomalies of the mechanical processing equipment can be accurately detected, thereby improving the yield of the processed workpiece.

### BRIEF DESCRIPTION OF DRAWINGS

The above and other aspects, features and advantages of specific embodiments of the present disclosure will become more apparent from the following description taken in conjunction with the accompanying drawings, in which:

FIG. 1 is a flow chart of a method for detecting abnormality according to an embodiment of the present disclosure;

FIG. 2 is an example graph of processing data of one type of workpiece according to an embodiment of the present disclosure;

FIG. 3 is another flow chart of a method for detecting abnormality according to an embodiment of the present disclosure;

FIG. 4 is an example graph of processing data of two kinds of workpieces according to an embodiment of the present disclosure; and

FIG. 5 is a schematic diagram of a system according to an embodiment of the present disclosure.

### DETAILED DESCRIPTION

Before proceeding to the following detailed description, it may be advantageous to set forth the definitions of certain words and phrases used throughout this disclosure. The terms “include” and “comprises” and their derivatives are meant to include, but are not limited to. The term “controller” or “control unit” refers to any device, system, or part thereof that controls at least one operation. Such a controller may be implemented with hardware, or a combination of hardware and software and/or firmware. The functionality associated with any particular controller may be centralized or distributed, whether local or remote. The phrase “at least one”, when used with a list of items, means that different combinations of one or more of the listed items may be used, and only one item in the list may be required. For example, “at least one of A, B, C” includes any one of the following combinations: A, B, C, A and B, A and C, B and C, A and B and C.

Definitions for other specific words and phrases are provided throughout this disclosure. Those of ordinary skill in the art should understand that in many, if not most instances, such definitions apply to prior and future uses of such defined words and phrases.

The various embodiments of the principles of the present disclosure described below in conjunction with the accompanying drawings are only for illustration, and should not be interpreted as limiting the scope of the present disclosure in any way. It will be appreciated by those skilled in the art that the principles of the present disclosure can be implemented in any appropriately arranged system or device. In some cases, the actions described in the present disclosure can be performed in different orders, and the desired results can still be achieved. In addition, the process depicted in the accompanying drawings does not necessarily require the specific order shown or the sequential order to achieve the desired results. In a specific embodiment, multitasking and parallel processing may be advantageous.

The text and drawings are provided as examples only to help understand the present disclosure. They should not be interpreted as limiting the scope of the claims attached to the present disclosure in any way. Although certain embodiments and examples have been provided, it is clear to those skilled in the art based on the content of the present disclosure that the embodiments and examples shown can be changed without departing from the scope of the present disclosure.

The mechanical processing equipment used throughout the present disclosure may include various general and special mechanical processing equipment, including but not limited to machine tools (e.g., grinding machines tools, lathes, drilling machines, boring machines, gear processing machines, screwing and threading machine, milling machines, planers, broaching machines, sawing machines and other machine tools, etc.), processing and manufacturing equipment (e.g., food processing equipment, textile equipment, chemical equipment, assembly equipment, etc.), etc.

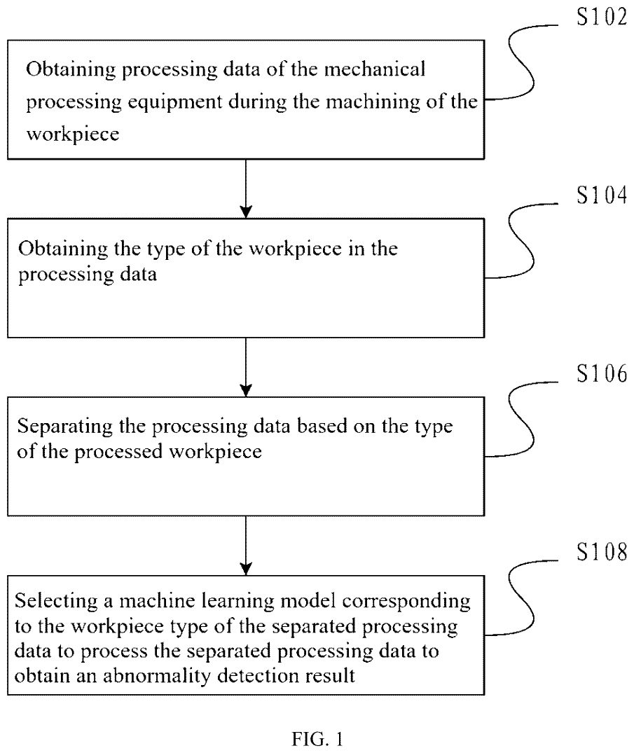

FIG. 1 is a flow chart of a method for detecting abnormality according to an embodiment of the present disclosure.

At step S102, processing data of the mechanical processing equipment during the machining of the workpiece may be obtained. The processing data may be collected by a sensor and may include data such as power, sound, vibration, force, speed, etc., but the present disclosure is not limited thereto. For example, the processing data may include at least one of the mechanical power output (e.g., the power of the grinding wheel spindle) and the electrical power received by the mechanical processing equipment during the machining of the workpiece. For example, the processing data may be sampled at a high sampling rate of at least 100 Hz.

At step S104, the type of the workpiece in the processing data may be obtained. For example, the type of the processed workpiece may include screws, gears, etc., but the present disclosure is not limited thereto.

At step S106, the processing data may be separated based on the type of the processed workpiece. The mechanical processing equipment may process different types of workpieces. Therefore, the processing data corresponding to each type of the processed workpiece may be separated from the processing data including the processing data of multiple types of processed workpieces.

At step S108, a machine learning model corresponding to the workpiece type of the separated processing data may be selected to process the separated processing data to obtain an abnormality detection result. The abnormality may include abnormal vibration or tremor, but the present disclosure is not limited thereto. The selected machine learning model may be used to process the processing data separated based on the workpiece type at step S106. For example, the selected machine learning model may be established or trained using previously extracted features of processing data of a specific workpiece type.

For example, a mechanical processing device can process different types of workpieces, and the processing data may include processing data of three types of workpieces A, B, and C. Due to the different types of workpieces, the pattern of machining data can change greatly, which makes it possible that the traditional method of anomaly detection of machining data by unified threshold is quite different from the actual situation. The abnormality detection may deviate greatly from the actual situation. According to the method disclosed in the present disclosure, the processing data can be separated based on the type of the workpiece being processed, and the data can be processed using the corresponding machine learning model to detect abnormalities. For example, the processing data of the workpiece of type A can be separated from the processing data, and the processing data of the workpiece of type A can be processed using the machine learning model corresponding to the workpiece of type A. In this way, the accuracy of abnormality detection can be improved, thereby improving the yield rate of the processed workpiece.

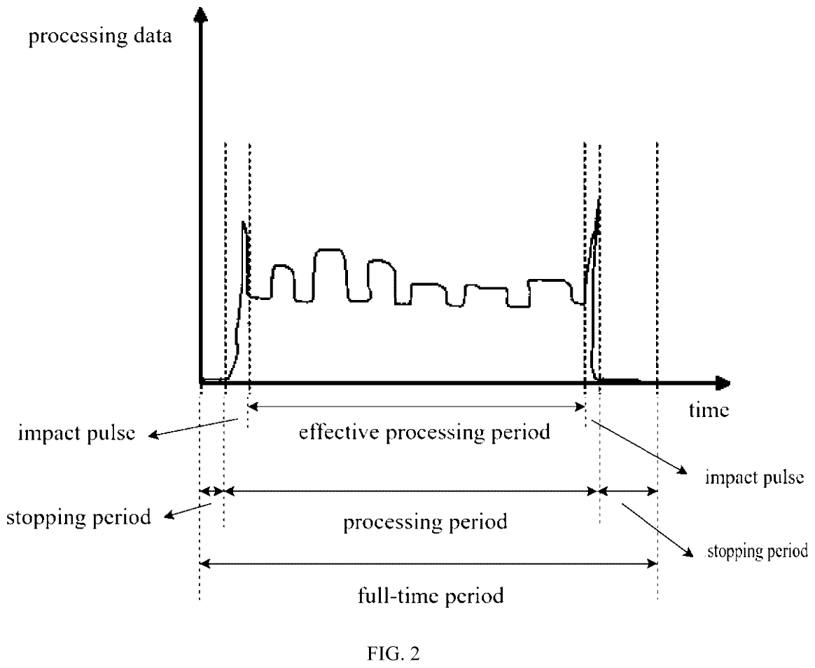

FIG. 2 is an example graph of processing data for one type of workpiece according to an embodiment of the present disclosure.

The mechanical processing equipment can process different types of workpieces, and the processing data can include processing data of different types of workpieces. The type of workpiece in the processing data and the separated processing data can be obtained by using the scheduling history in the mechanical processing equipment. For example, the scheduling history can be stored in the mechanical processing equipment, and the scheduling history can record the types and machining times of all workpieces processed by the mechanical processing equipment during a certain time period. Based on the workpiece type and the machining time, the processing data can be separated. For example, the processing data of different types of workpieces can be separated based on the scheduling history, and further, the processing data of a single workpiece in the processing data of the same type of workpiece can be separated based on the scheduling history.

FIG. 2 shows a full-time graph of the processing data of a type of workpiece after separation. As shown in FIG. 2, the full-time graph includes a processing period and a stopping period. The mechanical processing equipment is not always in a processing state during the process of machining the workpiece. In other words, the mechanical processing equipment may not process the workpiece for a certain length of time, but is in a turned off or standby state. The period between two processing periods is a stopping period. The processing period includes an effective processing period, a processing start period, and a processing end period. In the processing start period and the processing end period, impact pulses occur due to the startup and shutdown of the mechanical processing equipment.

The full-time processing data may include processing data during the processing period and processing data during the stopping period. For example, processing data during the processing period may refer to data of the actual processing of the workpiece by the mechanical processing equipment. Processing data during the stopping period may refer to data of the mechanical processing equipment itself during the time when the mechanical processing equipment does not process the workpiece. For example, processing data during the stopping period may approach 0. In order to obtain more accurate abnormality detection results, processing data during the stopping period may be identified and removed from the full-time processing data to obtain processing data during the processing period. By processing the processing data during the processing period in the separated processing data using a selected machine learning model corresponding to the workpiece type of the separated processing data, an abnormality detection result may be obtained more accurately.

The processing data during the stopping period can be removed from the full period processed data based on a machine learning classification model or based on a threshold. For example, the processed data with an amplitude lower than a threshold can be determined as the processing data during the stopping period and removed from the full-period processing data to obtain the processing data during the processing period.

In another embodiment, the processing data during the stopping period may be determined based on a machine learning classification model, thereby removing the processing data during the stopping period from the full period processing data.

A machine learning classification model trained using previously acquired processing data during the processing period and processing data during the stopping period may be used. Features of the processing data during the processing period and processing data during the stopping period may be extracted by root mean square (RMS), peak to peak (P2P), mean value, standard deviation, Envolop3, time-frequency transform (such as FFT transform), numerical operation, etc.

In one embodiment, the machine learning classification model may include a distribution-based machine learning model (such as 3sigma, Z-score, boxplot, etc.), a distance-based machine learning model (such as K-nearest neighbor (KNN)), a density-based machine learning model (such as Local Outlier Factor (LOF), Connectivity-Based Outlier Factor (COF), Stochastic Outlier Selection (SOS), etc.), a clustering-based machine learning model (such as Density-Based Spatial Clustering of Applications with Noise (DBSCAN), etc.), a tree-based machine learning model (such as Isolation Forest (iForest), etc.), a dimensionality reduction-based machine learning model (such as Principal Component Analysis (PCA), AutoEncoder, etc.), a classification-based machine learning model (such as One-Class SVM)) etc.), prediction-based machine learning models (such as moving average, autoregressive integrated moving average model (ARIMA), etc.). Although the example embodiments show some machine learning classification models, those skilled in the art should understand that the above description is merely exemplary and not exhaustive, and other existing or future developed machine learning classification models may be used, all of which are within the contemplation of the present disclosure.

As shown in FIG. 2, the processing data during the processing period may include impact pulse data and processing data during the effective processing period. The mechanical processing equipment may generate a large impact pulse when it is started up and shut down. The impact pulse may be significantly higher than the processing data during normal processing of the workpiece by the mechanical processing equipment. In order to obtain more accurate abnormality detection results, the impact pulse data of the mechanical processing equipment when it is started up and shut down may be identified, and the impact pulse data of the mechanical processing equipment when it is started up and shut down may be removed from the processing data during the processing period to obtain the processing data during the effective processing period. By processing the processing data during the effective processing period in the separated processing data using a selected machine learning model corresponding to the workpiece type of the separated processing data, a more accurate abnormality detection result may be obtained.

In one embodiment, based on the find peaks function, impact pulse data can be identified from the processing data during the processing period, and the impact pulse data of the mechanical processing equipment at started up and shut down can be removed from the processing data during the processing period to obtain processing data during the effective processing period.

In another embodiment, the impact pulse data of the mechanical processing equipment at start up and shut down can be removed from the processing data of the processing period based on the machine learning classification model or based on the threshold value. For example, the processing data with an amplitude higher than the threshold value can be determined as the impact pulse data, and it can be removed from the full-period processing data to obtain the processing data during the processing period.

In another embodiment, the impact pulse data may be determined based on a machine learning classification model, thereby removing the impact pulse data from the processing data during the processing period.

A machine learning classification model can be trained using previously acquired processing data during the effective processing period and impact pulse data. The features of the processing data during the effective processing period and impact pulse data can be extracted through root mean square (RMS), peak to peak (P2P), average value, standard deviation, envelope 3 (Envolop3), time-frequency transformation (such as FFT transformation), numerical operation, etc.

The types of machine learning classification models used to identify impact pulse data may be similar to the types of machine learning classification models used to identify processing data during the stopping period mentioned above, and will not be described in detail here.

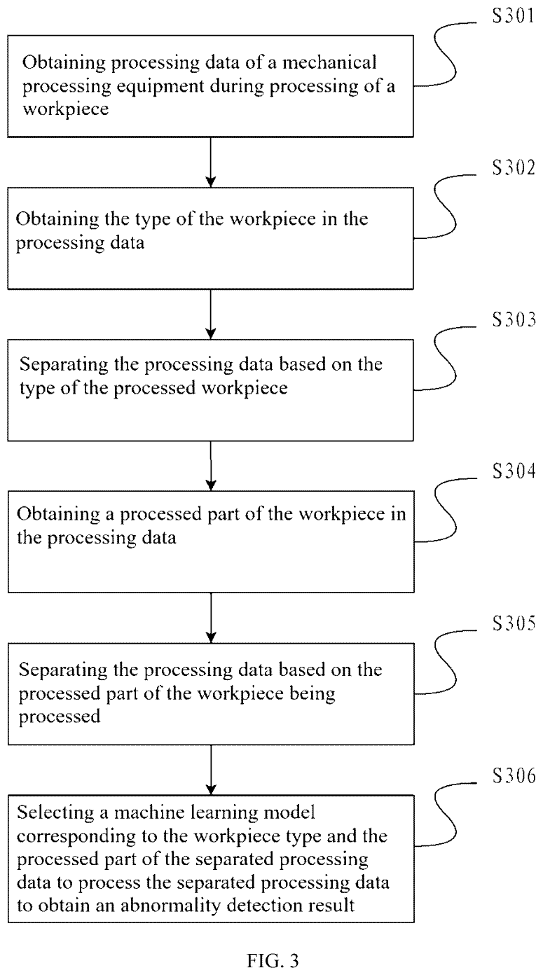

FIG. 3 is another flow chart of a method for detecting abnormality according to an embodiment of the present disclosure.

At step S301, processing data of a mechanical processing equipment during processing of a workpiece may be obtained. For example, the processing data may include at least one of the mechanical power output (e.g., the power of the grinding wheel spindle) and the electrical power received by the mechanical processing equipment during the machining of the workpiece. For example, the processing data may be sampled at a high sampling rate of at least 100 Hz. For other descriptions of the processing data, reference may be made to the description of step S102 in FIG. 1.

At step S302, the type of the workpiece in the processing data may be obtained. For example, the type of the processed workpiece may include screws, gears, etc., but the present disclosure is not limited thereto.

At step S303, the processing data may be separated based on the type of the processed workpiece. The mechanical processing equipment may process different types of workpieces. Therefore, the processing data corresponding to each type of the processed workpiece may be separated from the processing data including the processing data of multiple types of processed workpieces.

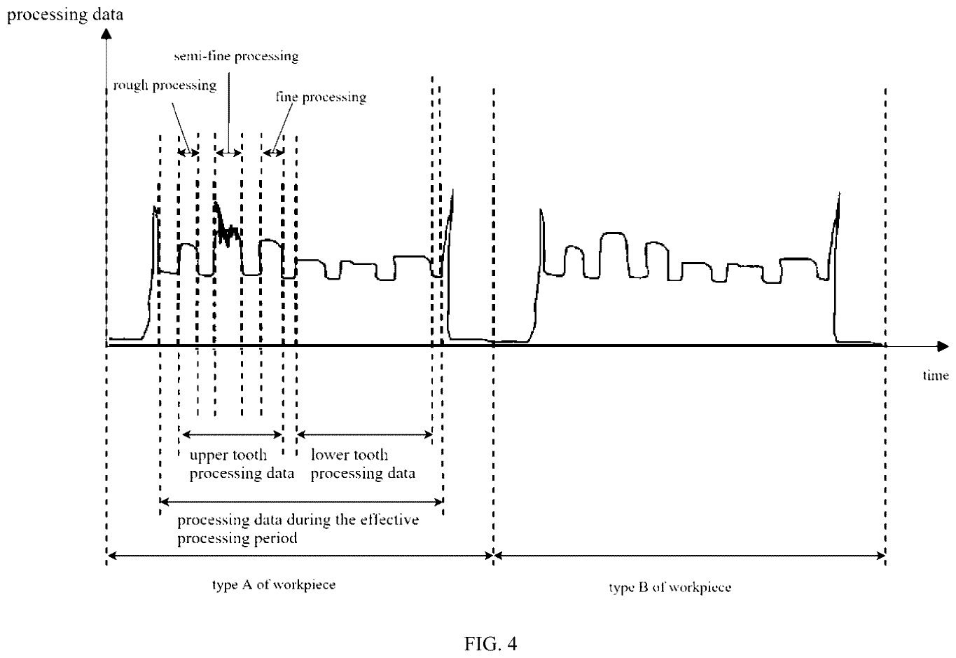

FIG. 3 is described with reference to FIG. 4. FIG. 4 is an example graph of processing data of a workpiece according to an embodiment of the present disclosure. As shown in FIG. 4, the processing data may include processing data of two types of processed workpieces (e.g., workpiece type A and workpiece type B). The type of workpiece in the processing data and the separation of processing data may be obtained by using a scheduling history in a mechanical processing device. For example, a scheduling history may be stored in the mechanical processing device, and the scheduling history may record the types and processing times of all workpieces processed by the mechanical processing device during a certain period of time. Based on the workpiece type and the processing time, the processing data may be separated into processing data of workpiece type A and workpiece type B.

In one embodiment, as described above, processing data during the processing period and processing data during the effective processing period in the processing data of the workpiece type A can be obtained. The process of obtaining the processing data during the processing period and the processing data during the effective processing period can be similar to that described in FIG. 2, and will not be repeated here.

Referring back to FIG. 3, at step S304, a processed part of the workpiece in the processing data may be obtained. For example, the workpiece may have multiple processed parts that need to be processed. For example, the processed part of the workpiece may include an upper tooth and a lower tooth, but the present disclosure is not limited thereto.

At step S305, the processing data can be further separated based on the processed part of the workpiece being processed. As shown in FIG. 4, the processing data during the effective processing period of workpiece type A can be further separated into upper gear processing data and lower gear processing data. Although FIG. 4 only further separates the processing data of workpiece type A, those skilled in the art can understand that similar separation can be performed on the processing data of workpiece type B.

Returning to FIG. 3, at step S304, the processing stage of the workpiece in the processing data may be further obtained. For example, the processing stage may include three stages: rough processing, semi-fine processing, and fine processing, but the present disclosure is not limited thereto.

At step S305, the processing data may be further separated based on the processing stage of the workpiece being processed. As shown in FIG. 4, the upper tooth processing data of workpiece type A may be further separated into a rough processing stage, a semi-fine processing stage, and a fine processing stage. Although FIG. 4 only further separates the upper tooth processing data of workpiece type A, those skilled in the art may understand that similar separation may be performed on the lower tooth processing data of workpiece type A and the processing data of workpiece type B.

Referring back to FIG. 3, at step S306, a machine learning model corresponding to the workpiece type and the processed part of the separated processing data may be selected to process the separated processing data to obtain an abnormality detection result. As shown in FIG. 4, an abnormality may be detected during the upper tooth processing of workpiece type A. By processing the separated processing data using the selected machine learning model corresponding to the workpiece type and the processed part of the separated processing data, an abnormality detection result may be obtained more accurately. For example, the selected machine learning model may be established or trained using features of processing data of a specific processed part of a specific workpiece type previously extracted.

Further, a machine learning model corresponding to the workpiece type, processed part, and processing stage of the separated processing data can be selected to process the separated processing data to obtain an abnormality detection result. For example, as shown in FIG. 4, an abnormality can be detected during the semi-fine processing stage in the upper tooth processing data of workpiece type A. By processing the separated processing data using a selected machine learning model corresponding to the workpiece type, processed part, and processing stage of the separated processing data, an abnormality detection result can be obtained more accurately. For example, the selected machine learning model can be established or trained using the features of the processing data of a specific processing stage of a specific processed part of a specific workpiece type that were previously extracted.

At steps S304-S305, the processed part and processing stage of the workpiece in the processing data can be obtained based on the mechanical processing principle or machine learning classification model of the processed workpiece.

In one embodiment, the number of times of processing of a workpiece and the processed part and processing stage corresponding to the number of times of processing can be determined based on the machining principle of the type of workpiece being processed. The processed part and processing stage of the workpiece can be determined by comparing the pulse count of the processing signal in the processing data during the effective processing period with the number of processing times based on the machining principle. For example, it can be determined based on the machining principle that a workpiece of workpiece type A needs to be processed 6 times, wherein the first three times are the upper tooth processing process and the last three times are the rear tooth processing process. In addition, it can be determined based on the machining principle that the three times of processing included in the upper tooth processing process are, in sequence, a rough processing process, a semi-fine processing process, and a fine processing process. In this way, the processed part and processing stage of the processed workpiece can be obtained, and the processing data corresponding to the workpiece type can be further separated.

In another embodiment, the processed part and processing stage of the workpiece in the processing data can be determined by a machine learning classification model. For example, the machine learning classification model for determining the processed part and processing stage of the workpiece in the processing data can include a decision tree, a random forest, a logistic regression, a naive Bayes, etc. Although the example embodiment shows some classification models using machine learning, it should be understood by those skilled in the art that the above description is only exemplary and not exhaustive, and other existing or future developed models for classification can be used to determine the processed part and processing stage of the workpiece in the processing data, all of which are within the scope of the present disclosure. The machine learning classification model can be trained by the features of the processing data of the processed part and processing stage of the workpiece previously obtained. For example, the features of the processing data of each processed part and each processing stage of various types of workpieces can be extracted by root mean square (RMS), peak to peak (P2P), mean value, standard deviation, Envolop3, time-frequency transform (such as FFT transform), numerical operation, etc.

The data association model can also be used to determine the processed part and processing stage of the workpiece in the processing data. The data association model can correspond to the data/signal preprocessing method. For example, the data association model can be used to obtain the correlation between the processing data and the previously obtained processing data, so as to select the processed part and processing stage corresponding to the high correlation based on the correlation sorting.

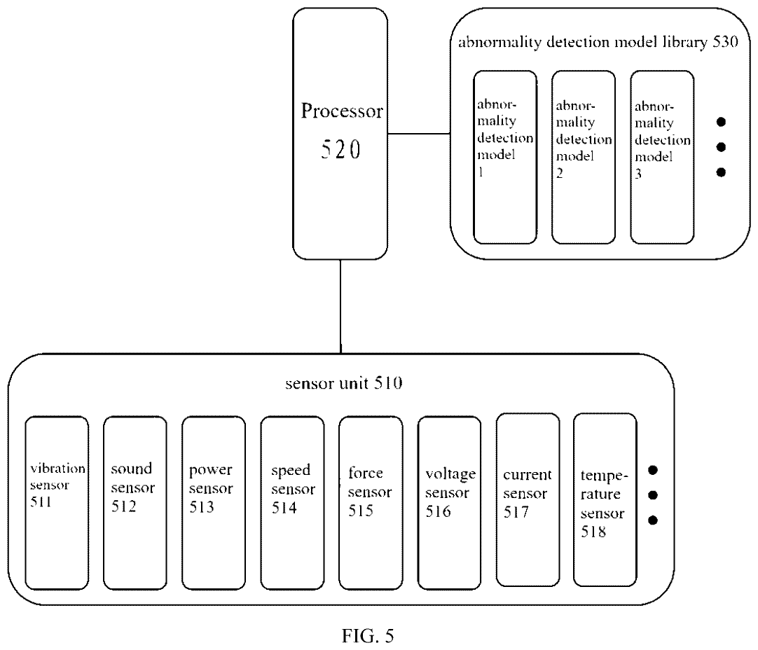

FIG. 5 is a schematic diagram of a system according to an embodiment of the present disclosure.

Although FIG. 5 does not show a storage device, it will be understood by those skilled in the art that the processor may include one or more storage devices on which instructions and/or data are stored. In addition, although FIG. 5 functionally shows the processor 520 and the sensor unit 510 as being within a single box, it will be understood by those skilled in the art that the processor 520 and the sensor unit 510 may actually include multiple processors 520 and multiple sensor units 510, which may or may not be stored in the same physical housing. Therefore, references to the processor 520 and the sensor unit 510 will be understood to include references to a collection of processors 520 and a collection of sensor units 510 that may or may not operate in parallel.

Processor 520 may be any conventional processing unit, such as a commercial CPU. Alternatively, processor 520 may be a dedicated device, such as an ASIC or other hardware-based control unit.

The sensor unit 510 may include more or fewer types of sensors than the various sensors shown in FIG. 5. The sensor unit 510 may collect processing data about the mechanical processing equipment.

In one embodiment, the vibration sensor 511 may include but is not limited to a mechanical vibration sensor, an optical vibration sensor, and an electrical vibration sensor (such as an inductive vibration sensor, an eddy current vibration sensor, a capacitive vibration sensor, a resistive strain vibration sensor, and a piezoelectric vibration sensor).

In one embodiment, the sound sensor 512 may include but is not limited to a piezoelectric ceramic acoustic sensor, a capacitive acoustic sensor, a magnetoelectric acoustic sensor, and the like.

In one embodiment, the power sensor 513 can obtain at least one of the mechanical power output (e.g., the power of the grinding wheel spindle) and the electrical power received by the mechanical processing equipment during the machining of the workpiece. Alternatively, at least one of the mechanical power output (e.g., the power of the grinding wheel spindle) and the electrical power received by the mechanical processing equipment during machining of the workpiece can be obtained by performing arithmetic operations on sensor data obtained by other sensors.

In one embodiment, the speed sensor 514 may include, but is not limited to, a photoelectric speed sensor, a magneto-electric speed sensor, a Hall speed sensor, and the like.

In one embodiment, the force sensor 515 may include but is not limited to a multi-component force sensor (e.g., a two-component, three-component, four-component, six-component force sensor), a torque sensor (e.g., a dynamic torque sensor and a static torque sensor), and an acceleration sensor (e.g., a single-axis acceleration sensor, a three-axis acceleration sensor).

In one embodiment, the voltage sensor 516 may include but is not limited to a voltage transformer, a Hall voltage sensor, a fiber optic voltage sensor, etc.

In one embodiment, the current sensor 517 may include but is not limited to a shunt, an electromagnetic current transformer, an electronic current transformer, etc.

In one embodiment, the temperature sensor 518 may include but is not limited to contact temperature sensors (such as bimetallic thermometers, glass liquid thermometers, pressure thermometers, resistance thermometers, thermistors, and thermocouples, etc.) and non-contact temperature sensors (such as various non-contact temperature sensors based on radiation thermometry including brightness method, radiation method, and colorimetry).

The connection between the processor 520 and the sensor unit 510 may be any connection capable of transmitting at least the processing data of the mechanical processing equipment output by the sensor to the processor 520. In one embodiment, the connection includes one or both of a cable connection and a wireless connection.

The cable connection form of the connection part may include a cable that transmits analog signals (e.g., voltage, 4-20 mA current) or digital signals (pulse, CAN, RS485, etc.). The cable form of the connection part is more suitable for applications that require high performance acquisition and high reliability.

The form of wireless connection can include various configurations and protocols, including short-range communication protocols such as Bluetooth™, Bluetooth™ LE, sub GHz, WirelessHART, infrared link, ZigBee, radio frequency identification (RFID), WiFi, Internet, World Wide Web, Intranet, Virtual Private Network, Wide Area Network, Local Area Network, Private network using communication protocols proprietary to one or more companies, Ethernet and HTTP, various cellular communication technologies such as GSM, CDMA, UMTS, EV-DO, WiMAX, LTE or 5th generation “5G” cellular technology and other cellular technologies developed in the future, and various combinations of the foregoing. The connection part in the form of wireless connection is more suitable for requirements such as easy installation and small size.

As described with reference to FIG. 1, the processor 520 can obtain processing data of the mechanical processing equipment during processing of the workpiece from the sensor unit 510, obtain the type of the workpiece in the processing data, separate the processing data based on the type of the processed workpiece, select a machine learning model corresponding to the workpiece type of the separated processing data from the abnormality detection model library 530 to process the separated processing data to obtain an abnormality detection result.

One or more of processor 520 and the abnormality detection model library 530 in FIG. 5 may be cloud-based, which may be advantageous when local computing power and storage space are insufficient or communication is smooth. One or more of the processor 520 and the abnormality detection model library 530 in FIG. 5 may be edge-based, which may be advantageous when local computing power and storage space are sufficient or communication is blocked.

According to an embodiment of the present disclosure, a computer-readable medium is provided, on which computer instructions are stored. When the computer instructions are executed by a processor, the processor executes a method for detecting faults and abnormalities of mechanical equipment.

Examples of storage media for providing program code include floppy disks, hard disks, magneto-optical disks, optical disks (such as CD-ROM, CD-R, CD-RW, DVD-ROM, DVD-RAM, DVD-RW), magnetic tapes, non-volatile memory cards, and ROMs. Alternatively, the program code may be downloaded from a server computer via a communication network.

According to the disclosed method for detecting abnormality, system, and storage medium for mechanical processing equipment, accurate fault abnormality detection results can be provided when the mechanical processing equipment processes different workpieces. The present disclosure can also detect early failures of mechanical equipment and provide maintenance suggestions to customers, thereby avoiding unplanned failures. By processing the processing data using an abnormality detection model related to the workpiece type, processed part, and processing stage, accurate abnormality detection of abnormalities in mechanical processing equipment can be performed, thereby improving the yield rate of processed workpieces.

The text and the accompanying drawings are provided as examples only to help understand the present disclosure. They should not be interpreted as limiting the scope of the present disclosure in any way. Although certain embodiments and examples have been provided, it is clear to those skilled in the art based on what is disclosed herein that the embodiments and examples shown may be changed without departing from the scope of the present disclosure.

Although the present disclosure has been described with exemplary embodiments, various changes and modifications may be suggested to one skilled in the art. The present disclosure is intended to encompass such changes and modifications as fall within the scope of the appended claims.

Any description in the present disclosure should not be construed as implying that any particular element, step, or function is an essential element that must be included in the claims scope. The scope of the patented subject matter is limited solely by the claims.

What is claimed is:

1. A method for detecting abnormality of a mechanical processing equipment, the method comprising:
obtaining processing data of the mechanical processing equipment during machining of a workpiece,
obtaining a type of the workpiece of the processing data,
separating the processing data based on the type of machined workpiece, and
selecting a machine learning model corresponding to the workpiece type of the separated processing data to process the separated processing data to obtain an abnormality detection result.

2. The method according to claim 1, wherein the processing data comprises at least one of mechanical power output and electrical power received by the mechanical processing equipment during machining of the workpiece.

3. The method according to claim 1, wherein the type of the workpiece in the processing data is obtained by using a scheduling history in the mechanical processing equipment and the processing data is separated.

4. The method according to claim 1, wherein obtaining processing data of the mechanical processing equipment during processing of the workpiece comprises:
obtaining the full-period processing data including processing data during the processing period and processing data during the stopping period,
removing the processing data during the stopping period from the full-period processing data to obtain the processing data during the processing period; and
wherein selecting the machine learning model corresponding to the workpiece type of the separated processing data to process the separated processing data includes processing the processing data during the processing period in the separated processing data.

5. The method according to claim 4, wherein the processing data during the stopping period is removed from the full-period processing data by a machine learning classification model or based on a threshold.

6. The method according to claim 4, wherein obtaining processing data of the mechanical processing equipment during processing of the workpiece further comprises:
removing the impact pulse data of the mechanical processing equipment at startup and shutdown from the processing data during the processing period to obtain the processing data during the effective processing period; and
wherein selecting the machine learning model corresponding to the workpiece type of the separated processing data to process the separated processing data includes processing the processing data during the effective processing period in the separated processing data.

7. The method according to claim 1, further comprising:
obtaining the processed part of the processed workpiece,
separating the processing data based on the type and processed part of the processed workpiece, and
selecting the machine learning model corresponding to the workpiece type and processed part of the separated processing data to process the separated processing data to obtain the abnormality detection result.

8. The method according to claim 7, further comprising:
obtaining the processing stage of the processed workpiece,
separating the processing data based on the type of the processed workpiece, the processed part and the processing stage, and
selecting the machine learning model corresponding to the workpiece type, processed part, and processing stage of the separated processing data to process the separated processing data to obtain the abnormality detection result.

9. The method according to claim 7, wherein the processed part of the workpiece and processing stage in the processing data are obtained based on the mechanical processing principle of the processed workpiece or machine learning classification model.

10. The method according to claim 8, wherein the processed part of the workpiece and processing stage in the processing data are obtained based on the mechanical processing principle of the processed workpiece or machine learning classification model.

11. An abnormality detection system for mechanical processing equipment, the abnormality detection system comprising:
a sensor unit including one or more sensors configured to collect processing data about the mechanical processing equipment;
an abnormality detection model library including one or more abnormality detection models configured to perform abnormality detection on mechanical processing equipment; and
a processor is configured to:
obtain processing data of the mechanical processing equipment during machining of a workpiece from the sensor unit,
obtain a type of the workpiece of the processing data,
separate the processing data based on the type of machined workpiece, and
select a machine learning model corresponding to the workpiece type of the separated processing data from the abnormality detection model library to process the separated processing data to obtain an abnormality detection result.
